(19) United States
(12) Patent Application Publication
(10) Pub. No.: US 2015/0166311 A1
(43) Pub. Date: Jun. 18, 2015

(54) Lifting Tripod, Sheave Assembly and Method

(71) Applicant: Jerry M. Flatterich, Lynnwood, WA (US)

(72) Inventor: Jerry M. Flatterich, Lynnwood, WA (US)

(21) Appl. No.: 14/570,450

(22) Filed: Dec. 15, 2014

Related U.S. Application Data
(60) Provisional application No. 61/916,192, filed on Dec. 14, 2013.
(60) Provisional application No. 61/924,837, filed on Jan. 8, 2014.

(51) Int. Cl. B66D 3/06; B66D 3/18

(52) U.S. Cl. CPC B66D 3/06; B66D 3/18

(57) ABSTRACT

A lifting tripod with a high point change of directional sheave assembly mounted transversely over the top surface of the tripod's upper head. The sheave assembly is aligned centrally over the tripod's vertical axis. The sheave assembly includes at least one vertical support plate with two longitudinally aligned front and rear sheaves attached thereto. The sheaves are space apart so that the front sheave is located directly over the upper end of the tripod's front leg and the rear sheave is located directly over the midline axis of a horizontal line that extends between the two rear legs. A pull line is extended over the two sheaves and the distal end of the pull line is then fed vertically downward over the tripod's center axis connected to an object to be lifted. The proximal end of the pull rope is attached to a pulling source mounted on the front leg or located laterally from the front leg.

Notice is given that the following patent document contains original material subject to copyright protection. The copyright owner has no objection to the facsimile or digital download reproduction of all or part of the patent document, but otherwise reserves all copyrights.

This utility patent application is based on and claims the filing date benefit of U.S. provisional patent application (61/916,192) filed on Dec. 14, 2013 and claims the filing date benefit of U.S. provisional patent application (61/924,837) filed on Jan. 8, 2014.

### BACKGROUND OF THE INVENTION

1. Field of the Invention

This invention pertains to tripods, and more particularly to accessories used with a tripod used to lift an object along the tripod's vertical center axis that allows the pulling source that applies a lifting force to a pull line to be positioned to one side of the tripod.

2. Description of the Related Art

When an individual or animal falls into a well, rescuers are called upon to remove the individual or animal from the well as soon as possible. Typically, the rescue team sets up a heavy duty tripod with the ends of the tripod's legs are placed on ground around the well and with a pull line that hangs downward from the tripod's head and travels through a tackle and block assembly. The distal end of the pull line is attached to a harness or belt placed around the trapped individual or animal. The proximal end of the pull line is attached to a pulling source, such as an electric winch, affixed to one of the tripod's leg. When the pulling source is activated, a lifting force is applied to the pull line thereby lifting the individual or animal from the well.

The space in between the tripod legs and under the tripod head is relatively small and usually occupied by rescuers. When the individual or animal is lifted from the well, the rescuers must grasp and stabilize the individual or animal and then disconnect the pull line from the harness or belt. When the pulling source is attached to the tripod leg, the pulling source can block access to the space under the tripod.

What is needed is an improved lifting tripod that uses a pull line that hangs downward from the tripod head over the tripod's vertical center axis but allows the pulling source to be removed from the tripod leg thereby providing greater access to the space under the tripod for rescuers.

### SUMMARY OF THE INVENTION

A lifting tripod with a high point change of directional sheave assembly mounted transversely over the top surface of the tripod's head. The tripod includes a front leg and two rear legs, diagonally aligned and equally spaced apart. The lengths legs may be fixed or telescopically adjustable. The upper ends of the legs connected to an upper head that includes three angle leg receiving sockets. The sheave assembly is centrally aligned over the tripod's center transverse axis and over the tripod's center vertical axis. When assembled, the sheave assembly is oriented so the front sheave is positioned directly over the tripod's front leg and the rear sheave is located over the midline axis that extends between the tripod's two rear legs.

More particularly, the sheave assembly includes a lower planar base with at least one upward extending, perpendicularly aligned support plate. Attached to the opposite ends of the support plate is a first sheave and a second sheave. In the embodiment shown, there are two parallel support plates with the two sheaves disposed between them and supported by separate axles. The support plates are perpendicularly aligned with and extend across the top surface of the head of the tripod. A means for connecting the planar base to the top surface of the tripod's upper head is also provided. In one embodiment, the means for connecting the planar base to the upper head is at least one nylon strap clamps the planar base over the top surface of the upper head. It should be understood that other types of means for connecting the planar base to the upper head may be used and that the planar base may be permanently attached or formed on the upper head.

In the embodiment show herein, formed on the end of the support plates are two jaws that extend downward and press against the vertical surface of the upper head disposed between the top receiving collars for the two rear legs. The two jaws prevent the sheave assembly from sliding laterally over the top surface of the head towards the front leg. The vertical ends of the support plates opposite the jaws terminate above the front leg. If the support base is permanently attached or formed on the support base, it should be understoond that the jaws may be eliminated.

The two sheaves are space apart on the support plates so the front sheave is located directly over the center axis of the tripod's front leg. The rear sheave is positioned directly above the mid-line axis between the tripod's two rear legs. The outer curved edge of the rear sheave extends slightly beyond the rear vertical edges of the two support plates which allow a pull rope to bypass the surface of the upper head and extends towards a block and tackle located below the upper head. An option guide rod extends across the two support plates and used to keep the pull rope aligned between the two sheaves when pulled.

During assembly, the distal end of the pull rope is attached to a strap, belt or harness attached to the object to be lifted. The pull rope then travels through the block and tackle and extends upward and over the rear sheave. The pull rope then travels horizontally between the two support plates, under the guide rod and over the front sheave. The pull rope then extends either to a pulling source, such as a mechanical or electric winch mounted on the front leg, or extends laterally and slightly downward to a pulling source located laterally a few or several feet away from the tripod.

When a pulling force is exerted to the proximal end of the pull line, the support plates which are held in fixed position on the upper head, downward forces are exerted by the sections of the pull rope located directly over the first and second sheaves. Because the first sheave is located directly over the front leg, downward force is applied to the front leg thereby securing it to the ground. Because the rear sheave is located directly over the midline axis of a horizontal line between the two rear legs, equal downward forces are applied on the rear legs also forcing them downward and securing them to the ground. Because the pulling force is located laterally to the tripod, the foot print space located directly under the tripod's upper head is unobstructed.

Using the above lifting tripod and sheave assembly, a method of vertically lifting a load using the lifting tripod with the pulling source located either on the front leg or laterally to the tripod is provided.

### DESCRIPTION OF THE DRAWINGS

FIG. 1 is a side elevational view of the lifting tripod with a sheave assembly mounted on the tripod's upper head with a pull line extending over the sheave assembly and then redirected downward into the foot print space located below the tripod's upper head.

FIG. 2 is a top plan view of the sheave assembly mounted on the tripod's upper head.

FIG. 3 is a side elevational view of the sheave assembly and the tripod's upper head shown in FIG. 2.

FIG. 4 is a front elevational view of the sheave assembly and the tripod's upper head shown in FIGS. 2 and 3.

FIG. 5 is a rear elevational view of the sheave assembly and tripod head shown in FIGS. 2, 3 and 4

FIG. 6 is a front perspective, partially exploded view of the sheave assembly.

FIG. 7 is a side elevational view of a vertical support plate.

FIG. 8 is perspective view of an optional rubber mat that fits under the planar base.

FIG. 9 is a top plan view of the planar support plate.

### DESCRIPTION OF THE PREFERRED EMBODIMENT(S)

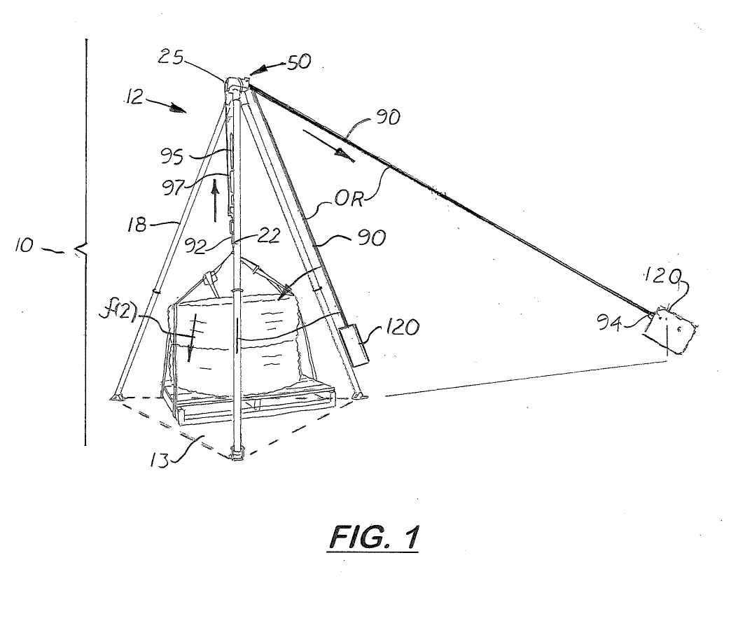

FIG. 1 show a lifting tripod 10 including a tripod 12 with a high point change of direction sheave assembly 50 mounted transversely over the lifting tripod's upper head 25. A pull line 90 extends over the sheave assembly 50 and connects at its distal end 92 to an object to be lifted. The proximal end 94 of the pull line 90 connects to a pulling source 120, shown as an electric or mechanical winch either attached to the front leg 14 or an electric or mechanical winch located laterally from the tripod 12 thereby leaving the foot print area 13 under the tripod 12 unobstructed. Because the pulling source 120 is activated, two downward forces, f(1), f(2) are exerted on the tripod's front leg 14 and the midline axis point ‘Y’ between the two rear legs 18, 22, respectively.

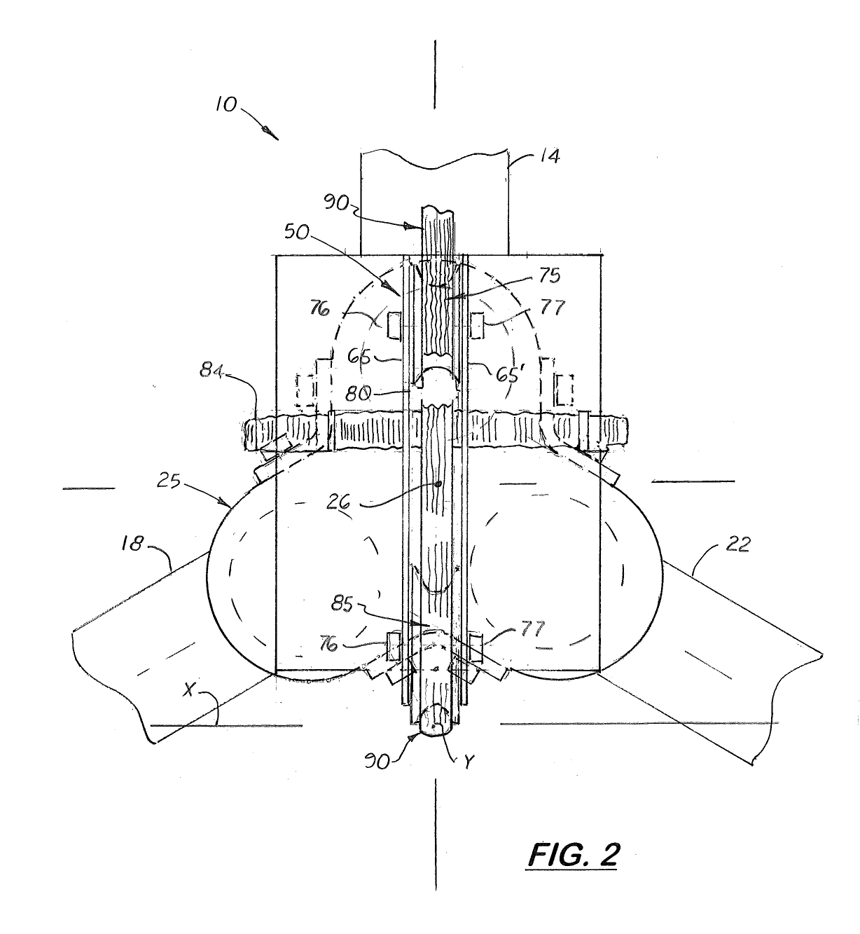

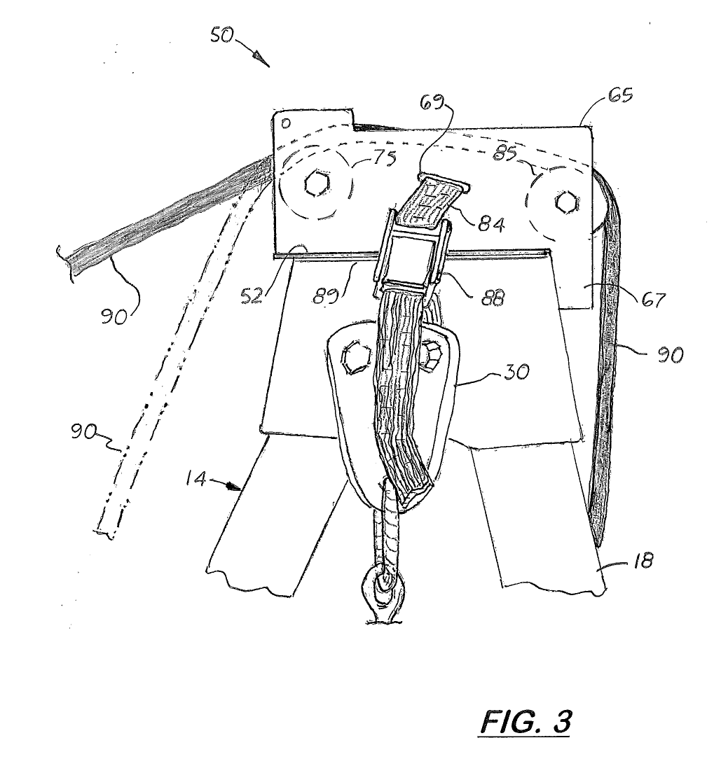

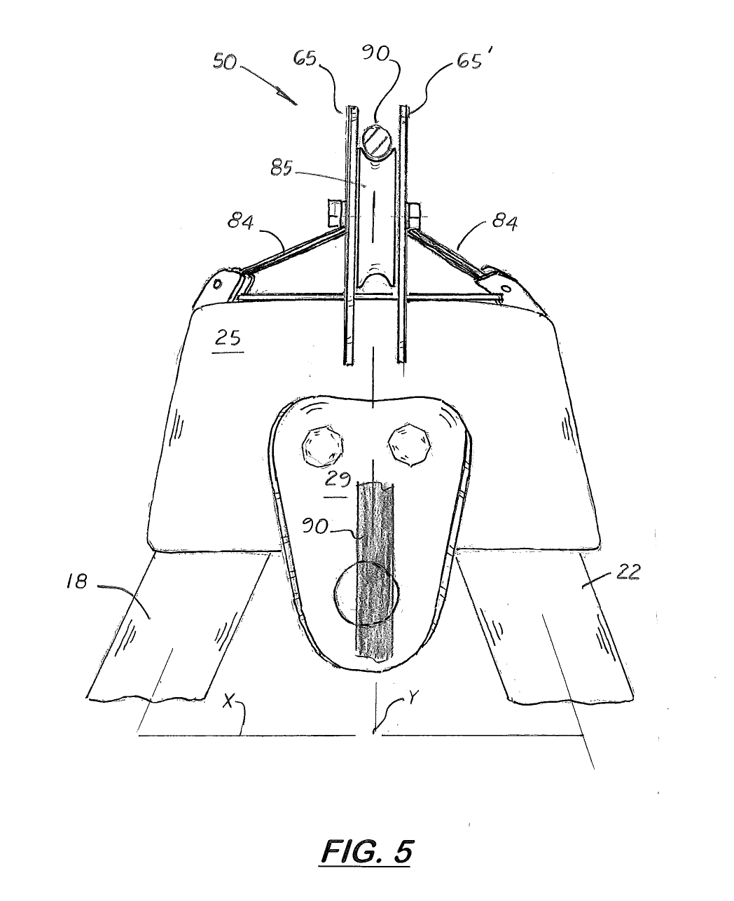

The sheave assembly 50 shown more clearly in FIGS. 2-5 includes a lower horizontal support base 52 located over the top surface of the upper head 25. Extending perpendicularly upward from the support base 52 is at least one vertical support plate 65. In the embodiment shown herein, two parallel support plates 65, 65′ are used. Mounted on the opposite ends of the two support plates 65, 65′ and in between the two support plates 65, 65′ is a first sheave 75 and a second sheave 75, 85. The first sheave 75 and the second sheave 85 are sufficiently spaced apart on the support members 65, 65′ so that the first sheave 75 is located directly over the upper end of the front leg 14 and the second sheave 85 is located directly over the midline axis point ‘Y” of a horizontal line ‘X’ that extends between the upper ends of the opposite rear legs 18, 22 (see FIG. 2).

After setting up the tripod 12 over the object 110 or a hole (not shown), the pull line 90 is extended over the front and rear sheaves 75, 85. The distal end 92 of the pull line 90 is then fed vertically downward into the footprint area 13 of the tripod 12 and directly connected to an object 110 to be lifted. In the embodiment shown in FIG. 1, the pull line 90 is first threaded between two blocks 95, 97 to create block and tackle assembly that creates a mechanical advantage. The distal end 94 of the pull line 90 then extends downward and connects to the object 110.

As stated above, the sheave assembly 50 is centrally aligned over the tripod's vertical axis 26 but also oriented over the upper ends of the legs 14, 18, and 22 so the sheave assembly's front sheave 75 is located over the upper end of the tripod's front leg 14 and the rear sheave 85 is located over the midline axis that extends between the upper ends of the tripod's two rear legs 18, 22.

More particularly, the sheave assembly 50 includes a lower planar support base 52 with two upward extending, perpendicularly aligned parallel support plates 65, 65′. The support plates 65, 65′ extend horizontally across the top surface of the upper head 25. The front and rear sheaves 75, 85 are disposed between them and supported by separate axles.

Formed on the end of the support plates 65, 65′ are two downward extending jaws 67, 67′, respectively, that press against the vertical rear surface of the upper head 25 located above and between the top ends of the two rear legs 18, 22. The two jaws 67, 67′ prevent the sheave assembly 50 from sliding horizontally over the top surface of the upper head 25 towards the front leg 14 when the pull line 90 is pulled by the pulling source 120. The ends 68, 68′ of the support plates 65, 65′ opposite the jaws 67, 67′, respectively terminate approximately over the upper end of the front leg 14.

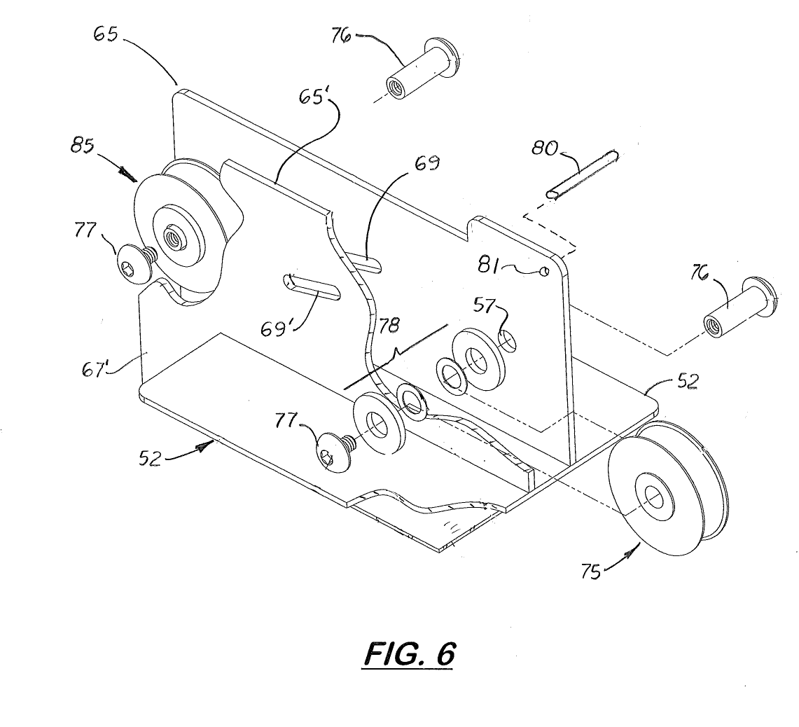

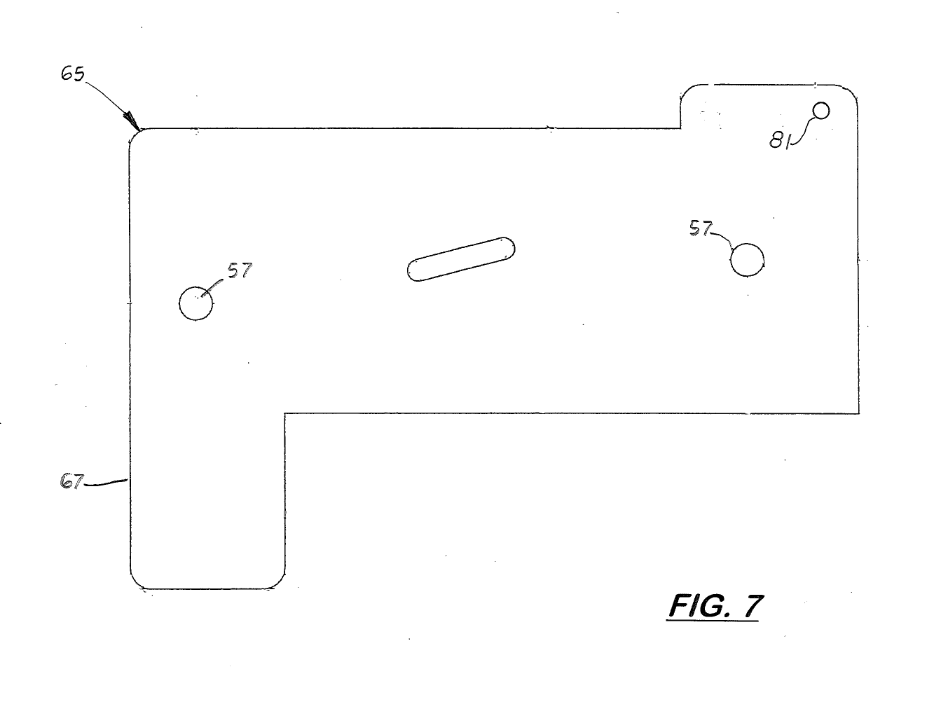

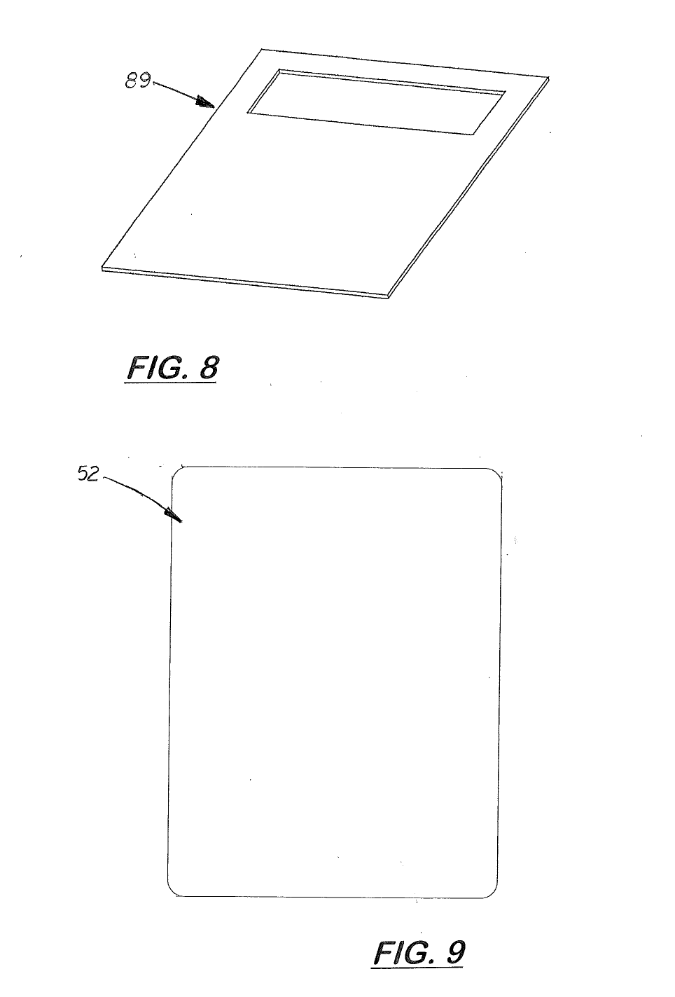

The two sheaves 75, 85 are spaced apart on the support plates 65, 65′ so that the front sheave 75 is located directly over the upper end of the tripod's front leg 14 and the rear sheave 85 is positioned directly above the mid-line axis between the two rear legs 18, 22. The outer edge of the rear sheave 85 extends beyond the jaws 67, 67′ on the support plates 65, 65′, respectively, to allow a pull line 90 to bypass the jaws 67, 67′ and extend downward and engage the block and tackle assembly located below the upper head 25. An option guide rod 80 extends across the upper edges of the two support plates 65, 65′ and used to keep the pull line 90 aligned between the two sheaves 75, 85 at all times. As shown more clearly in FIG. 6, the front and rear sheaves 75, 85 each rotate around transversely axle 76 that extends between the two support plates 65, 65′. Threaded connectors 77 extend through holes and hold the axles 76 in places. A set washers 78 are provided to allow the sheaves 75, 85 to rotated freely. Each support plate 65, 65′ also includes a guide rod hole 80 that receives the guide rod 80.

In the embodiment shown in the drawings, the sheave assembly 50 is separate structure designed to be selectively attached to the tripod's upper head 25 when needed. It should be understood however, that the sheave assembly 50 may be formed or permanently mounted on the tripod's upper head 25 in some embodiments.

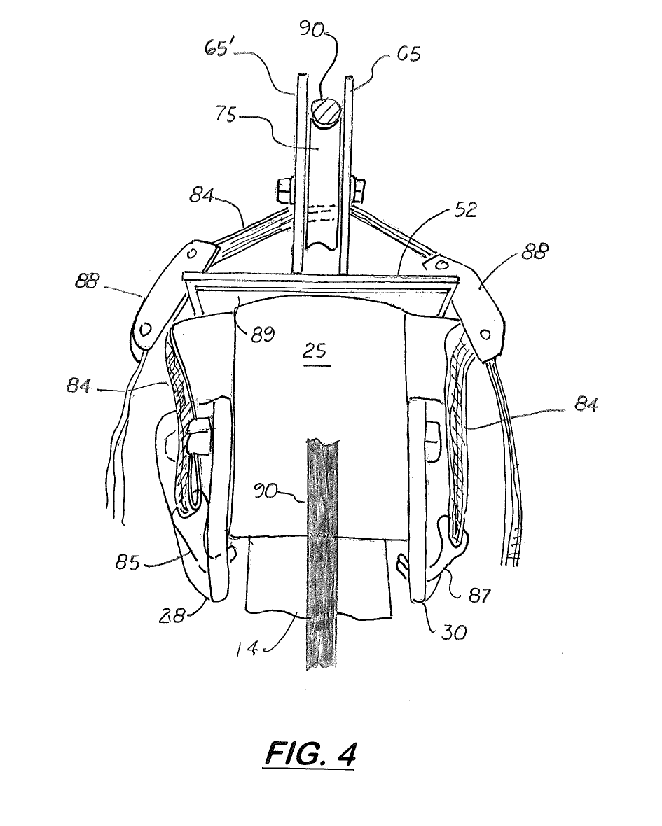

In the embodiment shown in the Figs, the sheave assembly 50 is held on the top surface of the upper head by and adjustable strap 84 that extends through two elongated slots 69, 69′ formed on upper portions of the two support plates 65, 65′, respectively. As shown in FIG. 4, attached to the opposite ends of the strap 84 are two hooks 85, 87 that attached to holes formed on two side clips 28, 30 that extend downward and attach to the sides of the upper head 25. The strap 84 includes at least one length adjuster 88 (two shown) or buckle that enable the user to tighten the strap 84 to securely hold the sheave assembly 50 in place over the upper head 25. It should be understood that the strap 84, hooks 85, 87 and adjuster 88 may be replaced by a mechanical clamp or bolts and nuts.

Also, disposed under the support base 52 is an optional rubber mat 89. During assembly, a pull line 90 travels through the two blocks 95, 97 and extends upward and over the rear sheave 85. The pull line 90 then travels horizontally between the two support plates 65, 65′, under the guide rod 80, and over the front sheave 75. The pulling source 120 may be mounted on the front leg 14 or it may be located laterally and slightly downward from the front leg 14. In both embodiments, the pulling source 120 is located slightly below the upper head 25. When a pulling force is exerted to the distal end 94 of the pull line 90, the strap 84 and the jaws 67, 67′on the support plates 65, 65, respectively, preventing the sheave assembly 50 from sliding laterally over the upper head 25.

In the embodiment shown in the Figs. the support base 52 is made of aluminum or steel and measures approximately 5 inches wide, 6½ inches long, and ⅛th inch thick. The two support plates 65, 65′ measure approximately 8¼ inches in length, and 3¾ inches in height. The two support plates 65, 65′ are approximately ¾ inches apart. The jaws 67, 67′ on each support plate 65, 65′, respectively, extend downward approximately 2 inches below the support plate's lower edge. The sheaves 75, 85 are approximately 2½ inches in diameter and ⅝ of an inch wide. The concave grooves inside the sheaves 75, 85 are designed to receive a ½ inch diameter pull line 90. The center axis of the sheaves 75, 85 are approximately 6 1/4 inches apart. The center axis of the front sheave 75 is approximately ¼ inches from the front edge of two support plates 65, 65′ . The center axis of the rear sleeve 85 is approximately ¼ inch from the rear edge of the two support plates 65, 65′.

The support plates 65, 65′each include an upward extending tab 69, 69′ formed near their front edges. Formed in each tab 69, 69′ is a guide rod hole that receives the guide rod 80 that extends across the two support plates 65, 65′. During assembly, the pull line 90 extends between the two sheaves 75, 85 and under the guide rod 80.

Using the above described lifting tripod 12 and sleeve assembly 50, a method of lifting an object 110 vertically using a lifting tripod 12 with the pulling source 120 located outside the tripod's footprint 13, comprising the following steps:
a. setting up a tripod 12 over an object to be lifted vertically, said tripod 12 includes a with a front leg 14 and two rear legs 18, 22 and an upper head 25 with a top surface 26;
b. attaching a sheave assembly 50 to said top surface 26 of said upper head 25, said sheave assembly 50 includes a lower horizontal support base 52 and at least one least one perpendicularly aligned support plate 65 , and two longitudinally aligned front and rear sheaves 75, 85 mounted on the same side and on opposite ends of said support plate 65, said support base 52 being aligned over said upper head 25 and said support plate 65 is aligned over said base so the front sheave 75 is located over the upper end of one said front leg 14 and the rear sheave 85 is located directly over the midline axis of a horizontal line that extends between the upper ends of said rear legs 18, 22;
c. setting up a pulling source 120 configured to apply a lifting force to an object 110 to be lifted by said lifting tripod 12, said pulling source 120 being either attached to the front leg and below the upper head 25 or located laterally from the ront leg 14 and below said upper head 25;
d. selecting a pull line 90 with a proximal end 92 and a distal end 94;
e. extending said distal end 94 of said pull line 90 over said front sheave 75 and over said rear sheave 85 and then extending said distal end 94 of said pull line 90 downward and connected to an object 110 located under said upper head 25 of said lifting tripod 12;
f. attaching our coupling said proximal end 92 of said pull line 90 to said pulling source 120; and,
g. activating said pulling source 120 to lift said object 110.

In compliance with the statute, the invention described has been described in language more or less specific as to structural features. It should be understood however, that the invention is not limited to the specific features shown, since the means and construction shown, comprises the preferred embodiments for putting the invention into effect. The invention is therefore claimed in its forms or modifications within the legitimate and valid scope of the amended claims, appropriately interpreted under the doctrine of equivalents.

I claim:

1. A lifting tripod, comprising:
a. a tripod with a front leg and two rear legs attached to a head, each said leg includes head evenly spaced 120 degrees apart;
b. a high point change of directional sheave assembly mounted transversely over the tripod's head, said sheave assembly includes a lower horizontal base located over the and at least one least one perpendicularly aligned support plate, mounted on the opposite ends of the support plate are two longitudinally aligned front and rear sheaves with the front sheave p located directly over the upper end of one said leg and the rear pulley located directly over the center point between the upper ends of the opposite said legs; and,
c. a pull line extended over the front and rear sheaves with the distal end of the pull line fed vertically downward over the center axis of the tripod and directly connected to an object to be lifted, or threaded between two blocks to create block and tackle assembly and then connected to the object, the opposite proximal end of the pull line is extended laterally from the front sheave and pulled by a pulling source.

2. A sheave assembly for a lifting tripod with a front leg and two rear legs by redirecting the pull line over the center axis of a tripod's upper head and directing the proximal end of the pull line either over the front leg or laterally from the front leg, comprising:
a. a support base disposed over the tripod upper head;
12
b. at least one vertical support plate extending upward and perpendicularly aligned with said support base, said support plate includes two opposite edges;
c. a front sheave attached to said support plate near one said front end;
d. a rear sheave attached to said support plate near said opposite end of said support plate; and;
e. a means for connecting said support base to said upper head of said lifting tripod so that said front sheave is located over the front leg and the rear sheave is located over a midline axis of a horizontal line that extends between said rear legs.

3. The sheave assembly as recited in claim 2, wherein said means for connecting said support base to said upper head is a length adjustable strap.

4. The sheave assembly, as recited in claim 2, wherein said means for connecting said support base to said upper head is a clamp.

5. The sheave assembly, as recited in claim 2, wherein said means for connecting said support base to said upper head is at least one threaded connector extending through said support base and said upper head.

6. The sheave assembly, as recited in claim 3, further including two parallel support plates with said front sheave and said rear sheave are located in between.

7. The sheave assembly, as recited in claim 6, wherein each said support plate includes a jaw that extends downward from said support base.

8. A method of lifting a load vertically using a tripod with the lifting source located outside the tripod's footprint, comprising the following steps:
a. setting up a lifting tripod over an object to be lifted vertically, said lifting tripod includes a with a front leg, two rear legs, and an upper head with a top surface;
b. attaching a sheave assembly to said top surface of said upper head , said sheave assembly includes a lower horizontal support base and at least one least one perpendicularly aligned support plate , and two longitudinally aligned front and rear sheaves mounted on the same side and on opposite ends of said support plate , said support base being aligned over said upper head and said support plate is aligned over said base so the front sheave is located over the upper end of one said front leg and the rear sheave is located directly over the midline axis of a horizontal line that extends between the upper ends of said rear legs;
c. setting up a pulling source configured to apply a lifting force to an object to be lifted by said lifting tripod , said pulling source being attached to said front leg or located located laterally to said front leg and below said upper head;
d. selecting a pull line with a proximal end and a distal end;
e. extending said distal end of said pull line over said front sheave and over said rear sheave and then extending said distal end downward and connected to an object located under said upper head of said lifting tripod;
f. attaching our coupling said proximal end of said pull line to said pulling source ; and,
g. activating said pulling source to lift said object.
